(19) United States
(12) Patent Application Publication
(10) Pub. No.: US 2007/0147094 A1
(43) Pub. Date: Jun. 28, 2007

(54) Bulb assembly

(76) Inventor: Hung-Wen Lee, Hsinchu Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,858

(22) Filed: Dec. 28, 2005

(51) Int. Cl. H01R 33/00

(52) U.S. Cl. 362/640

(57) ABSTRACT

A bulb assembly includes a shell, a holder, and a bulb, wherein the bulb and the holder are received in the shell. The shell has two conductive slices inside, each of which is provided with an active slice inclined inward. A V-shaped elastic slice, particularly an elastic steel piece, is placed under the active slice for providing enough elastic force to push the active slice with an upward potential. When the bulb and the holder are released from the shell, two active slices can contact with each other to keep the electrical connection of the light string that obtains the improved utilization.

### BACKGROUND OF THE INVENTION

In prior art, a light string connects with many bulb assemblies to emit light ray for a decorative purpose. Since each bulb assembly is serially connected with each other, the string will be out off work when any bulb assembly is released from the string. In order to solve this problem, a conventional design, U.S. Pat. No. 6,257,740, provides two folded conductive slices in its shell, wherein the inner elastic end of each slice can elastically contact with each other as the holder and the bulb are released from the shell to maintain electrical connection of the string. This design obtains a certain effect but is still lack of enough utility. Because the folded slice will be broken usually after being used for a period of time or two conductive slices can not contact with each other due to the elastic character being lost under long time compress in the shell.

Accordingly, the present invention is to provide an improved bulb assembly for using in a light string that overcomes the drawback of known structures. It includes an inner V-shaped elastic slice to provide enough elastic force for conductive slices being connected with each other when the holder and the bulb is released from the shell that makes sure of the electrical connection of the string. Now, accompanying with drawings, the character and structure of the present invention will be disclosed as following.

### BRIEF DESCRIPTION OF THE DRAWINGS

FIG. 1 is an exploded plan view showing a bulb assembly according to the present invention.

FIG. 2 is an assembled view of FIG. 1.

FIG. 3 is a perspective view showing a conductive slice with a V-shaped elastic slice according to the present invention.

FIG. 4 is a perspective view showing a modified conductive slice of the present invention.

### DETAILED DESCRIPTION OF THE EMBODIMENT

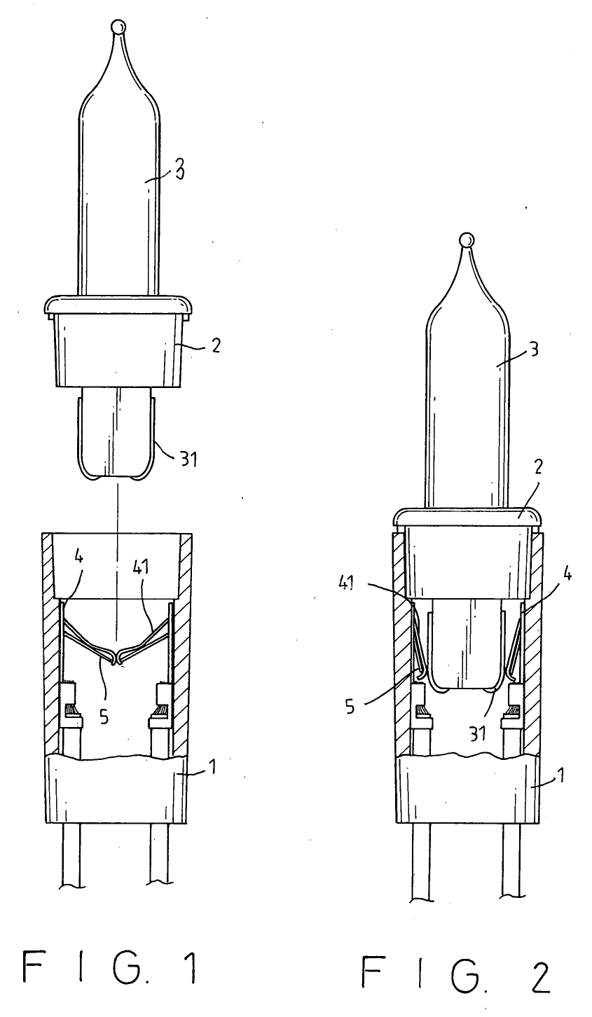

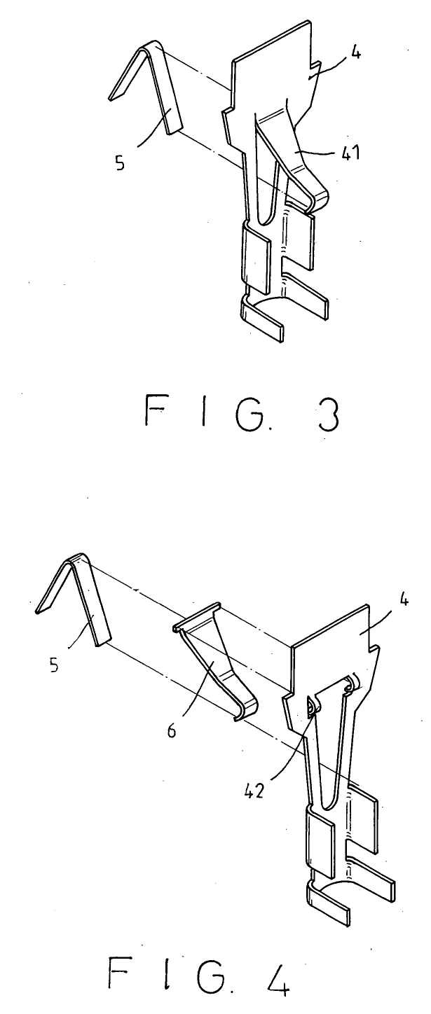

Please refer to FIG. 1 to 3, the present invention includes a shell (1), a holder (2), and a bulb (3), wherein the bulb (3) has two conductive wires (31) passing through the holder (2) for connection. The shell (1) has two conductive slices (4) inside, each of which is formed with an active slice (41) from central portion and is inclined inward. The characteristic of the present invention is to provide a V-shaped elastic slice (5), particularly an elastic steel piece, under the active slice (41) for providing enough elastic force to push the active slice (41) with an upward potential. Hence, when the holder (2) and the bulb (3) are released from the shell (1), two active slices (41) can thus contact with each other, as shown in FIG. 1, that keeps electrical connection for the light string without cutting off and reaches the purpose of this invention. On the other hand, the elastic force of the V-shaped slice (41) provides a better contact between the active slice (41) of the conductive slice (4) and the conductive wire (31) of the bulb (3).

Referring to FIG. 4, the conductive slice (4) can be provided with a separated active slice (6), which has inner projections (61) to engage with related hooks (42) formed on the slice (4). The V-shaped elastic slice (5) is still placed under the active slice (6) for providing a pushing force to obtain the same effect as description aforesaid.

Accordingly, the present invention uses the V-shaped elastic slice for providing enough force to maintain the electrical current in the bulb assembly being connection always. That, therefore, makes sure of the light string being used in normal all the time. Hence, the present invention obtains all elements of a patent and should be allowed.

I claim:

1. A bulb assembly including a shell, a holder, and a bulb, wherein the bulb having two conductive wires passing through the holder for connection, the shell having two conductive slices inside, each of which is formed with an active slice from central portion and is inclined inward, and the characteristic is to provide a V-shaped, elastic slice under the active slice for providing enough elastic force to push the active slice with an upward potential.

2. The bulb assembly as claimed in claim 1, wherein the active slice is separated from the conductive slice while the V-shaped slice is placed under the separated active slice.

3. The bulb assembly as claimed in claim 1, wherein the V-shaped elastic slice is made of elastic steel.
